(19) United States
(12) Patent Application Publication
(10) Pub. No.: US 2016/0353437 A1
(43) Pub. Date: Dec. 1, 2016

(54) System and Method for Reserving Unlicensed Spectrum

(71) Applicant: Futurewei Technologies, Inc., Plano, TX (US)

(72) Inventors: Yishen Sun, Clarksburg, MD (US); Hao Bi, Lake Zurich, IL (US)

(21) Appl. No.: 15/160,025

(22) Filed: May 20, 2016

Related U.S. Application Data
(60) Provisional application No. 62/166,374, filed on May 26, 2015.

(51) Int. Cl. H04W 72/04; H04W 72/08

(52) U.S. Cl. CPC H04W 72/0446; H04W 72/085

(57) ABSTRACT

A method for reserving a shared channel in a wireless communications system includes when a first device has a communications to start at a first time, determining, by the first device, a push-forward duration in accordance with at least quality of service (QoS) information associated with the communications, and performing, by the first device, at least one clear channel assessment (CCA) to reserve the shared channel at a second time that is before the first time by the push-forward duration.

This application claims the benefit of U.S. Provisional Application No. 62/166374, filed on May 26, 2015, entitled “System and Method for Utilizing Quality of Service Information in Reserving an Unlicensed Channel for Long Term Evolution System,” which application is hereby incorporated herein by reference.

This application is related to the following co-assigned patent application application Ser. No. 14/634477, filed on Feb. 27, 2015, entitled “System and Method for Reserving a Channel for Coexistence of U-LTE and Wi-Fi,” which application is hereby incorporated herein by reference.

### TECHNICAL FIELD

The present disclosure relates generally to digital communications, and more particularly to a system and method for reserving unlicensed spectrum.

### BACKGROUND

The amount of data traffic exchanged between wireless communication devices continues to grow rapidly. The ever-increasing traffic loads lead to a pressing need for additional spectral resources of cellular systems. In order to meet the capacity requirements caused by the increase in data traffic, operators are deploying more small cells and utilizing all available spectrum resources. While mobile broadband in licensed spectrum is highly efficient due to its exclusive occupancy of the spectrum, the amount of available licensed spectrum can be limited and costly. Bandwidth-rich unlicensed spectrum can be used to effectively augment the capacity.

The Third Generation Partnership Project (3GPP) Long Term Evolution (LTE) is currently among the most advanced mobile telecommunication technologies. LTE operating in licensed spectrum is prominently deployed across the world. To further expand LTE capacity to meet growing traffic demands, developers are looking to integrate unlicensed carriers into LTE systems by adapting LTE air interfaces to operate in the unlicensed spectrum. This is often referred to as unlicensed LTE (U-LTE), or LTE License Assisted Access (LTE-LAA).

### SUMMARY OF THE DISCLOSURE

Example embodiments provide a system and method for reserving unlicensed spectrum.

In accordance with an example embodiment, a method for reserving a shared channel in a wireless communications system is provided. The method includes when a first device has a communications to start at a first time, determining, by the first device, a push-forward duration in accordance with at least quality of service (QoS) information associated with the communications, and performing, by the first device, at least one clear channel assessment (CCA) to reserve the shared channel at a second time that is before the first time by the push-forward duration.

In accordance with another example embodiment, a first device is provided. The first device includes a processor, and a computer readable storage medium coupled to the processor and storing programming for execution by the processor. The programming including instructions to configure the first device to when the first device has a communications to start at a first time, determine a push-forward duration in accordance with at least QoS information associated with the communications, and perform at least one CCA to reserve a shared channel at a second time that is before the first time by the push-forward duration.

In accordance with another example embodiment, a non-transitory computer-readable medium storing programming for execution by a processor is provided. The programming including instructions to when a first device has a communications to start at a first time, determine a push-forward duration in accordance with at least QoS information associated with the communications, and perform at least one CCA to reserve a shared channel at a second time that is before the first time by the push-forward duration.

Practice of the foregoing embodiments enables a station to adaptively determine when to reserve a shared channel (e.g., unlicensed spectrum) in order to support quality of service (QoS) requirements, traffic type, and so on. If the station fails to reserve the shared channel, the station can adjust when to repeat the attempt to reserve the shared channel in order to support the QoS requirements. The adjustment is in accordance with the QoS requirements, as well as the failures in previous attempts to reserve the shared channel. Because the determination of when to attempt to reserve the shared channel is based on the QoS requirements, traffic type, and the failures in previous attempts to reserve the shared channel, the station is able to increase the likelihood of being successful in reserving the shared channel sufficiently early to support the QoS requirements.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example wireless communications system according to example embodiments described herein;

FIG. 2A illustrates a first example deployment scenario for a U-LTE communications system according to example embodiments described herein;

FIG. 2B illustrates a second example deployment scenario for a U-LTE communications system according to example embodiments described herein;

FIG. 3 illustrates an example frame structure for a 3GPP LTE time division duplex (TDD) mode according to example embodiments described herein;

FIG. 4A illustrates a diagram of a first example shared channel state according to example embodiments described herein;

FIG. 4B illustrates a diagram of a second example shared channel state according to example embodiments described herein;

FIG. 4C illustrates a diagram of a third example shared channel state according to example embodiments described herein;

FIG. 4D illustrates a diagram of a fourth example shared channel state according to example embodiments described herein;

FIG. 5 illustrates a flow diagram of first example operations occurring in a U-LTE device communicating over a shared channel according to example embodiments described herein;

FIG. 6 illustrates a flow diagram of second example operations occurring in a U-LTE device communicating over a shared channel according to example embodiments described herein;

FIG. 7A illustrates an example UE according to example embodiments described herein;

FIG. 7B illustrates an example base station according to example embodiments described herein;

FIG. 8 illustrates a block diagram of an embodiment processing system for performing methods described herein; and

FIG. 9 illustrates a block diagram of a transceiver adapted to transmit and receive signaling over a telecommunications network.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the embodiments and ways to operate the embodiments disclosed herein, and do not limit the scope of the disclosure.

One embodiment relates to systems and methods for reserving unlicensed spectrum. For example, when a first device has a communications to start at a first time, the first device determines a push-forward duration in accordance with quality of service (QoS) information associated with the communications, and performs at least one clear channel assessment (CCA) in attempting to reserve the shared channel at a second time that is before the first time by the push-forward duration.

The embodiments will be described with respect to example embodiments in a specific context, namely communications systems with multiple devices that use unlicensed spectrum or both licensed and unlicensed spectrum. The embodiments may be applied to standards compliant communications systems, such as those that are compliant with Third Generation Partnership Project (3GPP) Long Term Evolution (LTE), Unlicensed LTE (U-LTE), IEEE 802.11, and the like, as well as non-standards compliant communications systems, with multiple devices that use unlicensed spectrum or both licensed and unlicensed spectrum. The embodiments may also be applied to mixed systems with devices that are compliant with multiple technical standards or devices that are non-standards compliant.

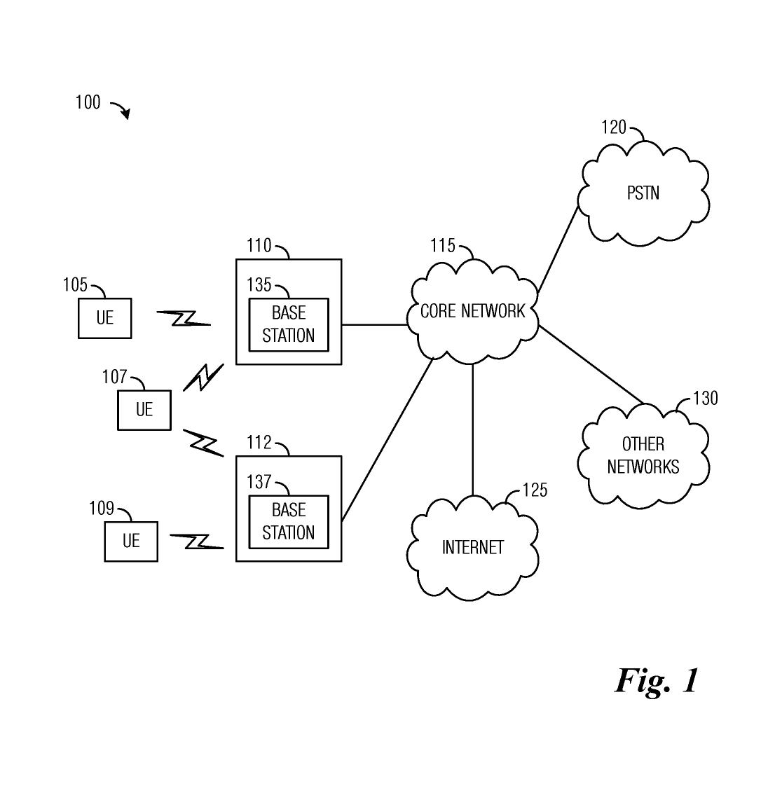

FIG. 1 illustrates an example wireless communications system 100. In general, wireless communications system 100 enables multiple wireless users to transmit and receive data and other content. Wireless communications system 100 includes user equipments (UEs), such as UE 105, UE 107, and UE 109, radio access networks (RANs), such as RAN 110 and RAN 112, a core network 115, a public switched telephone network (PSTN) 120, the Internet 125, and other networks 130. While it is understood that communications systems may employ multiple RANs capable of communicating with a number of UEs, only two RANs, three UEs, as well as a limited number of networks, are illustrated for simplicity.

The UEs are configured to operate and/or communicate in wireless communications system 100. As an example, the UEs are configured to transmit and/or receive wireless signals. It is noted that the UEs may be referred to as mobiles, mobile stations, users, subscribers, terminals, subscriber units, pagers, telephones, personal digital assistants, smartphones, computers, pads, tablets, devices, and so on. The RANs include base stations, such as base station 135 of RAN 110 and base station 137 of RAN 112. The base stations are configured to wirelessly interface with one or more UEs. As an example, base station 135 wirelessly communicates with UE 105 and UE 107, while base station 137 wirelessly communicates with UE 107 and UE 109 in the example shown. The wireless communications with the base stations enable the UEs to access core network 115, PSTN 120, the Internet 125, and/or other networks 130. It is noted that the base stations may also be referred to as base transceiver stations (BTS), NodeBs, evolved NodeBs (eNB), home NodeBs, home eNBs, access points (AP)s, site controller, servers, switches, communications controllers, and so on.

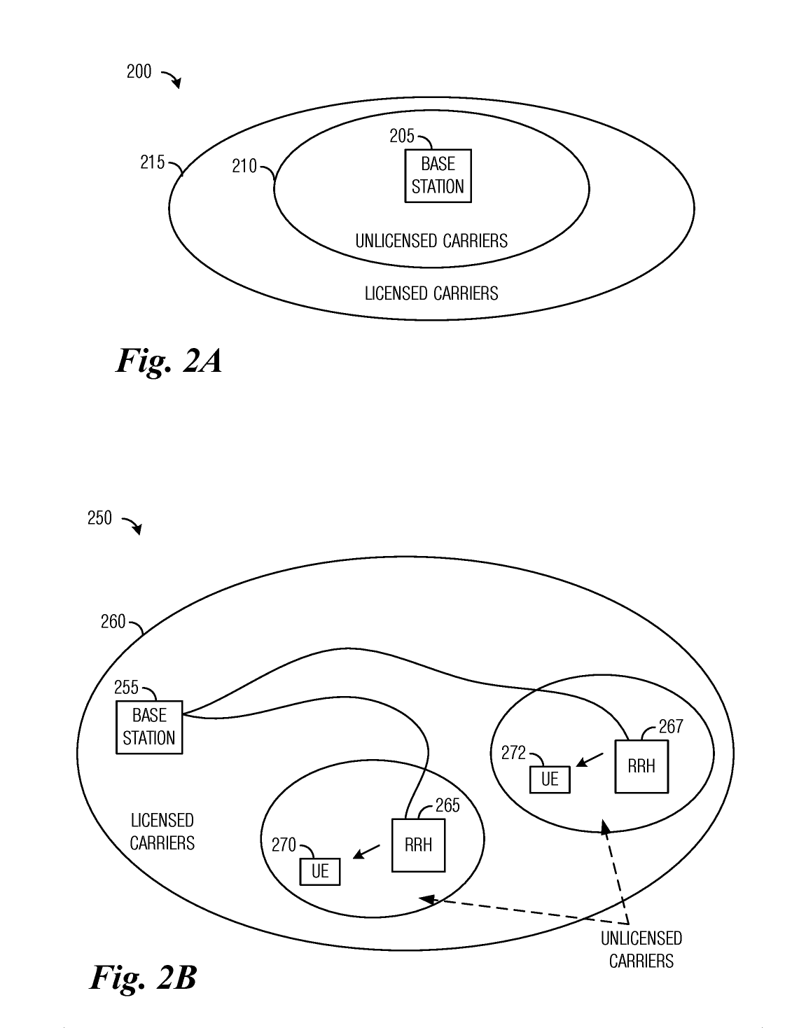

FIG. 2A illustrates a first example deployment scenario for a U-LTE communications system 200. As shown in FIG. 2A, U-LTE communications system 200 is in a co-located deployment, where a base station 205 provides coverage in both unlicensed carriers 210 and licensed carriers 215. The use of license carriers and/or unlicensed carriers by base station 205 may be dependent upon factors such as a relative location of a UE within the coverage area of base station 205, availability of resources in the licensed and unlicensed carriers, amount of information being transmitted, a priority of the UE, a priority of the transmission, quality of service (QoS) requirements of the UE and/or the transmission, and so forth. Base station 205 may be implemented using a Micro cell or a Pico cell, for example.

FIG. 2B illustrates a second example deployment scenario for a U-LTE communications system 250. As shown in FIG. 2B, U-LTE communications system 250 includes base station 255 that provides coverage in licensed carriers 260. Base station 255 is connected to remote radio heads (RRHs), such as RRH 265 and RRH 267. A RRH may be viewed as a remote antenna or antenna array controlled by a base station to provide increased coverage or improved performance. As shown in FIG. 2B, the RRHs provide coverage in unlicensed carriers. As an example, in addition to or in lieu of transmitting directly to UEs (such as UE 270 and UE 272), base station 255 instructs the RRHs to transmit to the UEs. The transmissions by base station 255 may utilize licensed carriers while the transmissions by the RRHs (in the example deployment shown in FIG. 2B) may utilize unlicensed carriers.

Some advantages of U-LTE include:
supporting unlicensed carriers paired with licensed carriers; and
integrating unlicensed spectrum into operator networks to achieve LTE-based unlicensed carrier offloading, which may alleviate resource backlogs in the licensed spectrum through the use of unlicensed carriers.

Many countries or regions have various regulatory requirements on accessing a shared radio channel, e.g., unlicensed carriers, such as those associated with listen before talk (LBT). LBT is a requirement in which a device or equipment performs a clear channel assessment (CCA) to “listen” before using the shared channel to “talk”. The performing of the CCA will generally result in a determination of the shared channel being either free or busy. If the shared channel is free, the device may utilize the shared channel and if the shared channel is busy, the device may not utilize the shared channel. In some implementations, even if the shared channel is free, the device may have to reserve the shared channel prior to using the shared channel.

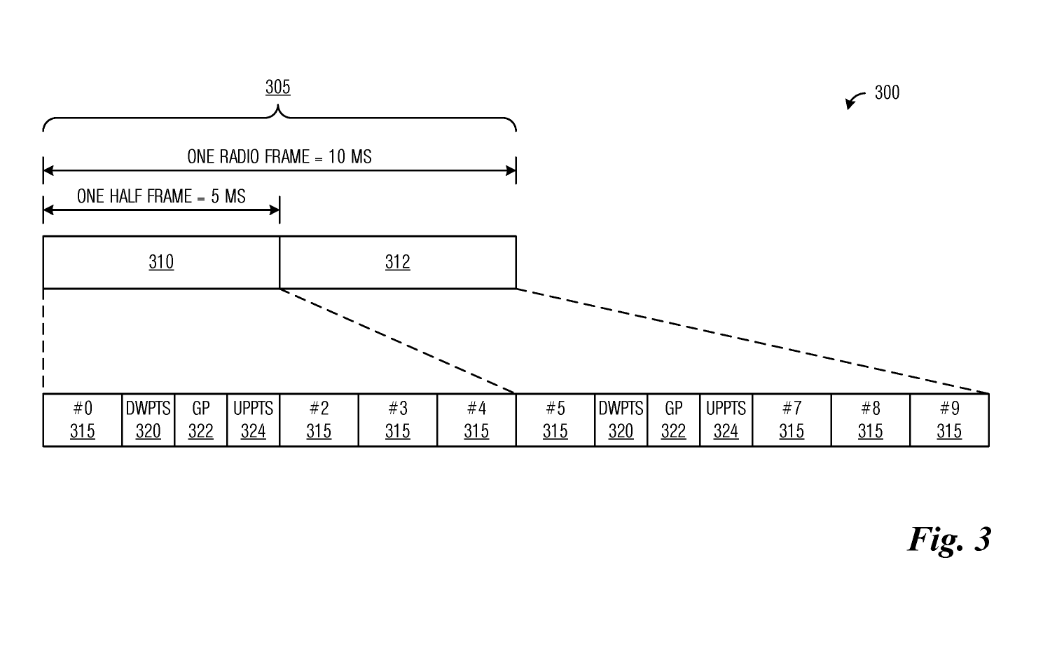

FIG. 3 illustrates an example frame structure 300 for a 3GPP LTE time division duplex (TDD) mode. In 3GPP LTE TDD, uplink and downlink are divided into radio frames. A radio frame 305 is 10 milliseconds (ms) in length and is divided into two half-frames that are 5 ms long each, a first half-frame 310 and a second half-frame 312. Depending on the configuration, each half-frame consists of either five slots 315, or four slots 315 plus three fields, (a downlink pilot time slot (DwPTS) 320, a guard period (GP) 322, and an uplink pilot time slot (UpPTS) 324), in a special subframe.

In LTE TDD, uplink and downlink transmissions are separated in the time domain. There are restrictions as to which subframes can be used for which transmission direction. The GP is a reserved period for downlink to uplink (or uplink to downlink) transition. Other subframes/fields are assigned for either downlink or uplink transmission. Table 1 shows various example uplink/downlink subframe allocations in a LTE TDD frame. As shown in Table 1, both 5 ms and 10 ms switch-point periodicities are supported. The radio frame 305 shown in FIG. 3 is an example of 5ms switch-point periodicity, and may correspond to one of Configurations 0, 1, 2, or 6 in Table 1.

TABLE 1
Uplink-Downlink allocations of LTE TDD frame

| | Switch- | | | | | | | | | | | |
|---|---|---|---|---|---|---|---|---|---|---|---|---|
| Config- | point | | Subframe number | | | | | | | | | |
| uration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

In U-LTE, a channel reservation mechanism can be used to determine whether or not a channel is busy, and reserve the channel for one or more U-LTE devices if the channel is free. The content of the channel reservation signaling used by U-LTE devices is understandable by U-LTE devices. Thus, such a channel reservation mechanism is sufficient for a communications system that includes only U-LTE devices. However, some communications systems include both U-LTE and other devices (e.g., Wi-Fi devices), such that one or more channels are shared between U-LTE and Wi-Fi. Some Wi-Fi devices (either access points (AP) or stations (STA)) cannot or are not required to interpret certain U-LTE-compatible signaling, such as the channel reservation signaling. Hence, the Wi-Fi devices will not be able to determine that the shared channel has been reserved and commences transmitting, which may prevent a U-LTE device that has reserved the shared channel from transmitting at the reserved time.

Accordingly, co-assigned U.S. patent application Ser. No. 14/634,477 discloses embodiment systems and methods for a push-forward channel reservation mechanism. The U-LTE device starts the observation and reservation of a shared channel at a predetermined amount of time before the preferred beginning of the desired communication (e.g., the beginning of the next sub-frame). This predetermined amount of time is referred to herein as the push-forward duration. When the U-LTE device is unable to reserve the channel, the U-LTE device repeats the reservation attempt until the reservation is successful, becoming more aggressive after each reservation failure. In addition, repetitive channel reservations can be made through deliberate transmission(s) on the shared channel after a successful initial reservation until the beginning of the actual data transmission, to ensure the coexistence of Wi-Fi and U-LTE devices, as described in greater detail below.

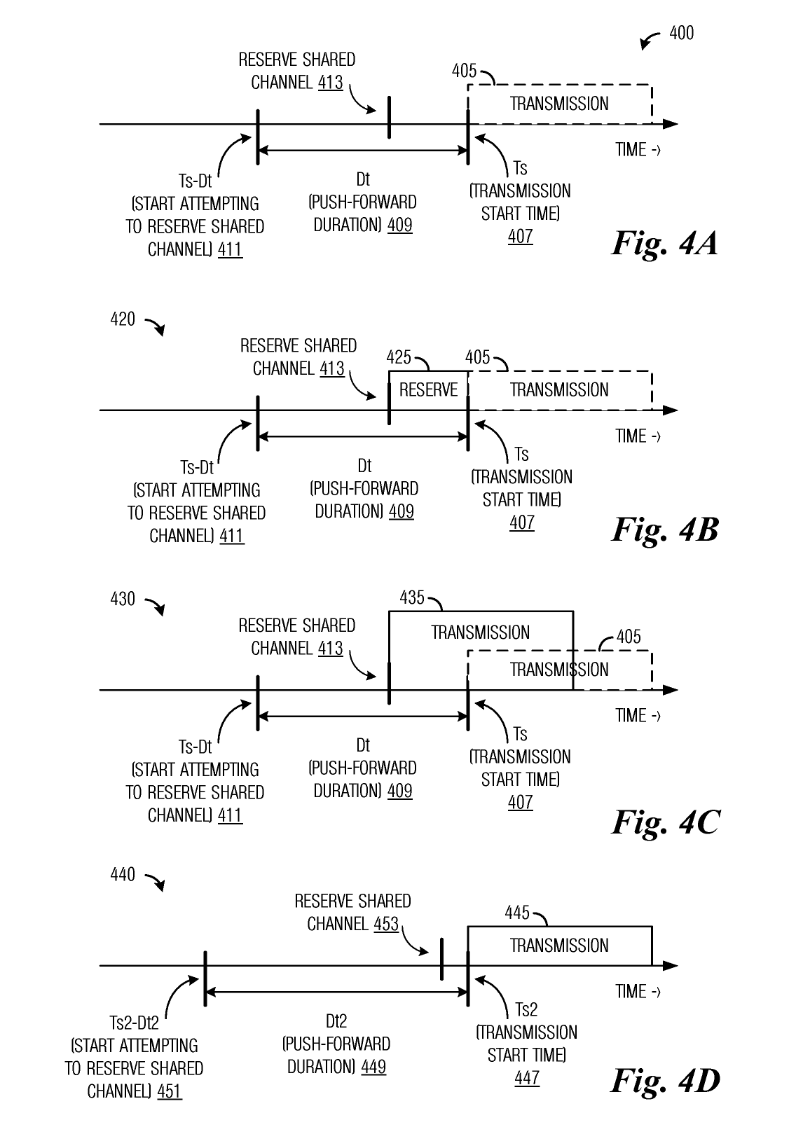

FIG. 4A illustrates a diagram of a first example shared channel state 400. As shown in FIG. 4A, a U-LTE device has a transmission 405 that has been determined by the U-LTE device to take place at a transmission start time T_{S} 407. Transmission start time T_{S} 407 may be aligned with a subframe boundary, for example. The U-LTE device determines a push-forward duration D_{T} 409, which specifies a time when the U-LTE device will start to attempt to reserve the shared channel. The time when the U-LTE device will start to attempt to reserve the shared channel is expressible as T_{S}-D_{T}. The reservation of the shared channel may be realized as the reservation of resources of the shared channel to allow the U-LTE device to perform transmission 405. The reservation of the shared channel may, as described previously, include the U-LTE device to perform one or more CCAs to determine the state of the shared channel. If the shared channel is free, the U-LTE device may reserve the shared channel, while if the shared channel is busy, the U-LTE device may have to wait for the shared channel to become free. As an illustrative example, if on a first CCA, the U-LTE device determines that the shared channel is busy, the U-LTE device may wait a specified interval (which may be set by a technical standard, an operator of the communications system, or so on) and then perform a second CCA. If the shared channel is again busy, the U-LTE device may wait another specified interval and perform a third CCA, and so on, until the shared channel becomes free or until it is too late to reserve the shared channel and transmit at time T_{S} 407. As shown in FIG. 4A, the U-LTE device is able to reserve the shared channel at time 413 and is able to make transmission 405 at transmission start time T_{S} 407.

FIG. 4B illustrates a diagram of a second example shared channel state 420. As shown in FIG. 4B, a U-LTE device has a transmission 405 that has been determined by the U-LTE device to take place at a transmission start time T_{S} 407. Transmission start time T_{S} 407 may be aligned with a subframe boundary, for example. The U-LTE device determines a push-forward duration D_{T} 409, which specifies a time when the U-LTE device will start to attempt to reserve the shared channel. The time when the U-LTE device will start to attempt to reserve the shared channel is expressible as T_{S}-D_{T}. The reservation of the shared channel may be realized as the reservation of resources of the shared channel to allow the U-LTE device to perform transmission 405. As shown in FIG. 4B, the U-LTE device is able to reserve the shared channel at time 413. However, a time difference between time 413 and transmission start time T_{S} 407 may be sufficiently great that a Wi-Fi device may be able to determine that the shared channel is free and make a transmission, which may overlap with transmission start time T_{S} 407. As an example, if the time difference is greater than an extended inter-frame space (EIFS) interval value, a Wi-Fi device may be able to initiate a transmission that extends into transmission start time T_{S} 407. In order to prevent other devices (U-LTE devices as well as Wi-Fi devices) from transmitting prior to transmission start time T_{S} 407, the U-LTE device makes one or more repetitive channel reservations 425 between time 413 and transmission start time T_{S} 407 to ensure that no other device is able to make a transmission on the shared channel. Although shown in FIG. 4B as beginning immediately once the U-LTE device is able to reserve the shared channel at time 413, the one or more repetitive channel reservations 425 may occur sometime after the U-LTE device is able to reserve the shared channel, as long as the one or more repetitive channel reservations 425 occur before another device (a U-LTE device or a Wi-Fi device) is able to transmit on the shared channel. Furthermore, the U-LTE device does not have to continuously reserve the shared channel. Instead, the U-LTE can reserve the shared channel, wait a period of time shorter than the minimum amount of time that would allow another device to transmit on the shared channel, and reserve the shared channel again, and so on. It is noted that between U-LTE devices, the 3GPP LTE channel reservation mechanism may be used. However, for Wi-Fi devices, the U-LTE device may need to use some alternative techniques, such as using transmission(s) of request to send (RTS) and clear to send (CTS) messages, to keep the shared channel busy until transmission start time T_{S} 407.

FIG. 4C illustrates a diagram of a third example shared channel state 430. As shown in FIG. 4C, a U-LTE device has a transmission 405 that has been determined by the U-LTE device to take place at a transmission start time T_{S} 407. Transmission start time T_{S} 407 may be aligned with a subframe boundary, for example. The U-LTE device determines a push-forward duration D_{T} 409, which specifies a time when the U-LTE device will start to attempt to reserve the shared channel. The time when the U-LTE device will start to attempt to reserve the shared channel is expressible as T_{S}-D_{T}. The reservation of the shared channel may be realized as the reservation of resources of the shared channel to allow the U-LTE device to perform transmission 405. As shown in FIG. 4C, the U-LTE device is able to reserve the shared channel at time 413. However, the U-LTE device does not make additional reservations to ensure that other devices do not try to transmit on the shared channel. As shown in FIG. 4B, the U-LTE device makes the transmission early, as close to time 413 as feasible based on the subframe structure being used, for example. The early transmission is shown as transmission 435. As an illustrative example, if transmission start time T_{S} 407 corresponds to the start of uplink subframe #4 of LTE TDD Configuration 0, the U-LTE device may be able to start transmission 435 at the start of uplink subframe #3 or the middle of uplink subframe #3 with a partial subframe transmission. Although shown in FIG. 4C as beginning immediately once the U-LTE device is able to reserve the shared channel, transmission 435 may occur sometime after the U-LTE device is able to reserve the shared channel, as long as transmission 435 occurs before another device (a U-LTE device or a Wi-Fi device) is able to transmit on the shared channel and while maintaining compatibility with the subframe structure.

FIG. 4D illustrates a diagram of a fourth example shared channel state 440. As shown in FIG. 4D, the U-LTE device has been unsuccessful in at least one previous attempt to reserve the shared channel. As an illustrative example, referring back to FIG. 4A, the U-LTE device was unsuccessful in reserving the shared channel during push-forward duration D_{T} 409. As a result, the U-LTE device will try again. The U-LTE device determines that it will transmit transmission 445 (potentially the same transmission as transmission 405 of FIG. 4A) at a transmission start time T_{S2} 447. The U-LTE device determines a push-forward duration D_{T2} 449, which specifies a time when the U-LTE device will start to attempt to reserve the shared channel. However, to help improve the probability that the attempt to reserve the shared channel is successful, the U-LTE device becomes more aggressive, and increases the push-forward duration. The increase in the push-forward duration is in accordance with the number of times the U-LTE device has unsuccessfully tried to reserve the shared channel using the push-forward duration technique. The time when the U-LTE device will start to attempt to reserve the shared channel is expressible as T_{S2}-D_{T2}. As shown in FIG. 4D, the U-LTE device is able to reserve the shared channel at time 453. Techniques such as those shown in FIGS. 4B and 4C may be used by the U-LTE device to prevent other devices from transmitting in the shared channel between time 453 and transmission start time T_{S2} 447.

Although shown in FIGS. 4A-4D as being used to make transmissions to other devices, the techniques presented herein are also operable in reserving the shared channel for receiving transmissions from other devices. Therefore, the focus on transmissions should not be construed as being limiting to either the spirit or scope of the example embodiments.

According to an example embodiment, the push-forward duration is determined in accordance with QoS requirements. In addition to determining the push-forward duration in accordance with the parameters for channel reservation, the QoS requirements are used to determine the push-forward duration. The need to support QoS requirements of the U-LTE device and/or a communications device communicating with the U-LTE device, such as latency tolerance, delay tolerance, U-LTE device priority, communications device priority, traffic priority, and so on, may impact the value of the push-forward duration. As an illustrative example, if the QoS requirements are strict, the push-forward duration should be large to ensure that the data is sent or received at the determined starting time. As another illustrative example, if the QoS requirements are loose, the push-forward duration may be small to reduce the amount of time the U-LTE device is attempting to reserve the shared channel, allowing the U-LTE device to perform other tasks, as well as conserve power. Because the QoS requirements are loose, there may be multiple opportunities for the data to be sent or received and it may not be imperative for the U-LTE device to immediately reserve the shared channel.

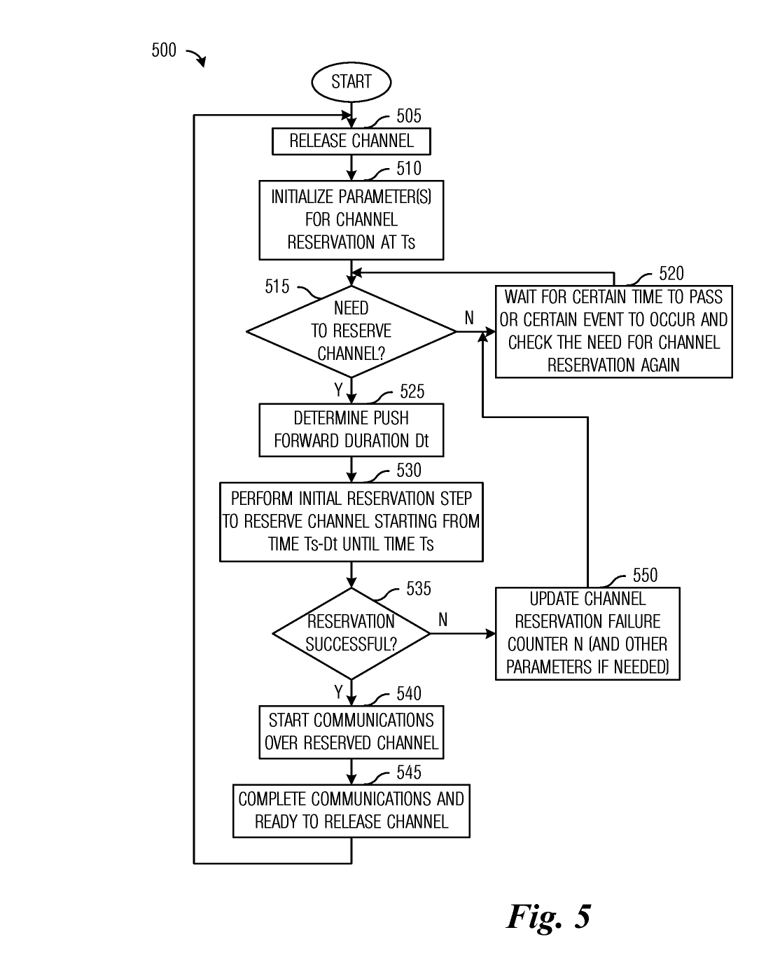

FIG. 5 illustrates a flow diagram of first example operations 500 occurring in a U-LTE device communicating over a shared channel. Operations 500 may be indicative of operations occurring in a U-LTE device as the U-LTE device communicates over a shared channel.

Operations 500 begin with the U-LTE device releasing the shared channel (block 505). The U-LTE device initializes one or more parameters for channel reservation (block 510). As an illustrative example, the U-LTE device initializes a channel reservation failure counter N to 0 or 1. The U-LTE device performs a check to determine if there is a need to reserve the shared channel starting at time T_{S} (block 515). As an illustrative example, the U-LTE device determines if there is any data to transmit or receive at time T_{S}. The time T_{S} may correspond to a subframe boundary, a half-frame boundary, a half-subframe boundary, or any other time landmark, event, or boundary. If there is no need to reserve the shared channel, the U-LTE device waits for a predetermined time to pass or an occurrence of a predetermined event to again check for the need to reserve the shared channel (block 520). As an illustrative example, the U-LTE device waits for another time slot, subframe duration, portion of subframe duration, or some other interval before attempting to reserve the shared channel again.

If there is a need to reserve the shared channel, the U-LTE device determines the push-forward duration D_{T} (block 525). The value of the D_{T} may be based on QoS information (such as QoS requirements of the U-LTE device, QoS requirements of the traffic, QoS requirements of the device communicating with the U-LTE device, U-LTE device priority, the priority of the device communicating with the U-LTE device, traffic priority, traffic type, and so on), as well as the parameters for channel reservation (such as the channel reservation failure counter N). As an illustrative example, D_{T}=QoS+f(N, Tcca, Trts-cts, Twifi), where f( )is a function operator, QoS is numerical representation of the QoS information, Tcca is the CCA observation time (as described in LBT rules), Trts-cts is the minimum time to complete a RTS/CTS handshake among two or more U-LTE devices, and Twifi is the maximum duration that a U-LTE device may wait before repeating the channel reservation activity in order to prevent one or more Wi-Fi devices from reserving the channel. As an example, Trts-cts is determined based on protocol design and network condition, e.g., a round trip time for exchanging RTS/CTS messages between U-LTE devices, the processing time at each device to respond, etc. As another example, Twifi may be set to an EIFS interval value because a Wi-Fi device will typically wait for an EIFS interval before attempting to make a channel reservation if the Wi-Fi device detects a signal that it cannot interpret.

As an example, if the U-LTE device is attempting to transmit data of high priority, the U-LTE may start competing for the shared channel earlier (i.e., make the push-forward duration greater). As another example, if the U-LTE device is attempting to transmit data of low priority or high latency tolerance, the U-LTE device may start competing for the shared channel later (i.e., make the push-forward duration smaller). As another example, if the U-LTE device is given a high priority, the U-LTE device may start competing for the shared channel earlier. As yet another example, if the U-LTE device is given higher priority over other U-LTE devices, an offset may be added to the push-forward duration of that U-LTE device. For example, D_{T}(UEi) =OFFSET(UEi)+f (N, Tcca, Trts-cts, Twifi), wherein OFFSET(UEi) is a non-negative numerical value of the U-LTE device. Furthermore, the offset may be a value including certain randomized factors such that UEs of the same priority level may start attempting to reserve the shared channel at different time instances to avoid collisions among themselves.

The U-LTE device performs steps involved in reserving the shared channel starting at time T_{S}-D_{T} until T_{S} (block 530). As an illustrative example, the U-LTE device may perform a CCA to determine if the shared channel is free. If the channel is free, the U-LTE device attempts to reserve the shared channel by performing an initial reservation setup, which may involve the U-LTE device transmitting an initial reservation signal. If the U-LTE device is unable to reserve the channel on a first try and if there is sufficient time remaining before time T_{S}, the U-LTE device waits a specified amount of time and repeats the attempt to reserve the shared channel. The U-LTE device may repeat the attempts to reserve the shared channel until there is insufficient time remaining before time T_{S}. The U-LTE device performs a check to determine if the reservation of the shared channel was successful (block 535). If the reservation of the shared channel was successful, the U-LTE device starts communications over the reserved shared channel (block 540). As an illustrative example, the U-LTE device transmits or receives data over a resource of the shared channel. The U-LTE device completes the communications and prepares to release the shared channel (block 545). If the reservation of the shared channel was not successful, the U-LTE device updates parameters for channel reservation (block 550). As an illustrative example, the U-LTE device updates the channel reservation failure counter N, e.g., the U-LTE device increments the channel reservation failure counter N. The U-LTE device returns to block 520 to wait for a predetermined time to pass or an occurrence of a predetermined event to again check for the need to reserve the shared channel.

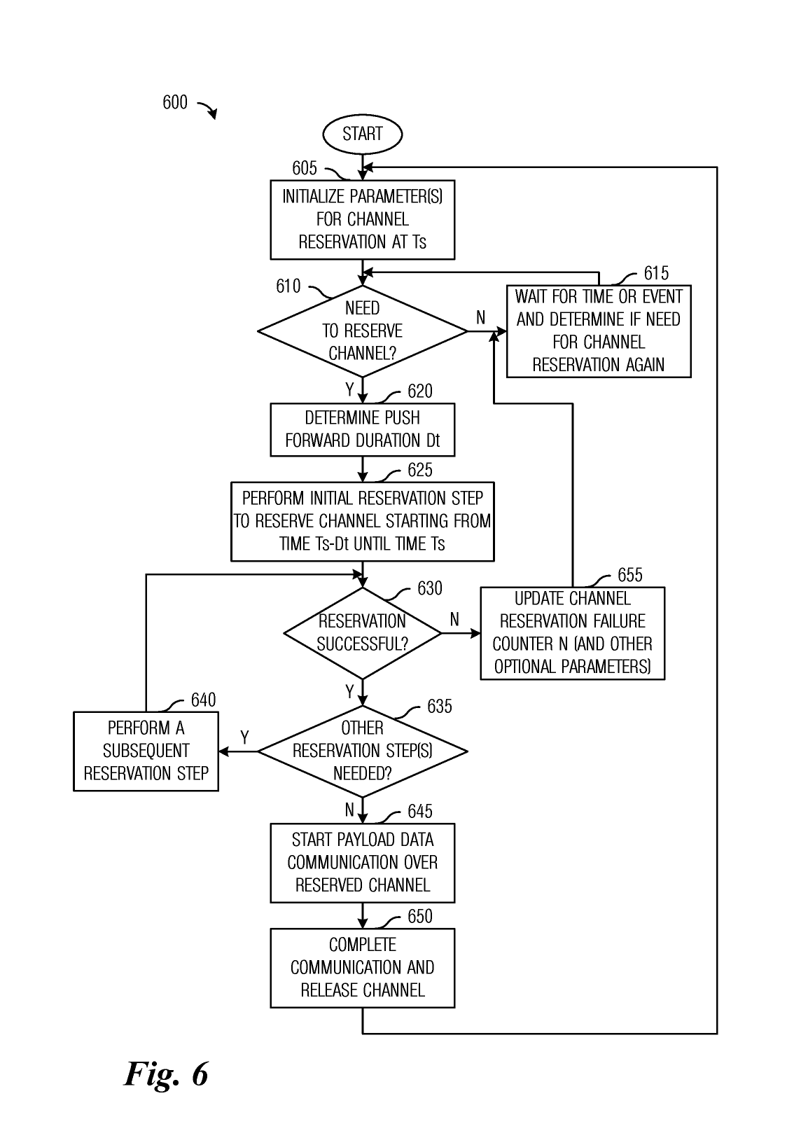

FIG. 6 illustrates a flow diagram of second example operations 600 occurring in a U-LTE device communicating over a shared channel. Operations 600 may be indicative of operations occurring in a U-LTE device as the U-LTE device communicates over a shared channel.

Operations 600 begin with the U-LTE device initializing one or more parameters for channel reservation (block 605). As an illustrative example, the U-LTE device initializes a channel reservation failure counter N to 0 or 1. The U-LTE device performs a check to determine if there is a need to reserve the shared channel starting at time T_{S} (block 610). If there is no need to reserve the shared channel, the U-LTE device waits for a predetermined time to pass or an occurrence of a predetermined event to again check for the need to reserve the shared channel (block 615). If there is a need to reserve the shared channel, the U-LTE device determines the push-forward duration D_{T} (block 620). The value of the D_{T} may be based on QoS information (such as QoS requirements of the U-LTE device, QoS requirements of the traffic, U-LTE device priority, traffic priority, and so on), as well as the parameters for channel reservation (such as the channel reservation failure counter N). The U-LTE device performs steps involved in reserving the shared channel starting at time T_{S}-D_{T} until T_{S} (block 625). Reserving the shared channel may involve reserving one or more resources associated with the shared channel at time T_{S}. The U-LTE device may have to repeat the attempts to reserve the shared channel until there is insufficient time remaining before time T_{S}.

The U-LTE device performs a check to determine if the reservation of the shared channel was successful (block 630). If the reservation of the shared channel was not successful, the U-LTE device updates parameters for channel reservation (block 655). If the reservation of the shared channel was successful, then to U-LTE devices, the shared channel is considered to be reserved. Furthermore, Wi-Fi devices were able to detect the messages exchanged during the reservation of the shared channel and will back-off prior to attempting to acquire the shared channel. However, the Wi-Fi devices may not understand the reservation of the shared channel using the 3GPP LTE channel reservation mechanism and will not consider the shared channel to be reserved. Therefore, the U-LTE device may still need to continue transmitting certain signals (periodically or continuously) to maintain the reservation of the shared channel. The U-LTE device performs another check to determine if other reservation steps are needed (block 635). As an example, if a time difference between the time when the U-LTE device is able to reserve the channel and the time T_{S} is smaller than an EIFS interval, then the U-LTE device may not need to perform additional reservation steps. However, if the time difference is greater than the EIFS interval, meaning that it is possible for a Wi-Fi device to initiate a transmission that extends into the time T_{S}, then the U-LTE device may need to perform additional reservation steps to protect the reservation of the shared channel (block 640). After performing the additional reservation steps, the U-LTE device returns to block 630 to determine if the reservation of the shared channel is still successful.

If the U-LTE device does not have to perform other reservation steps, the U-LTE device starts communications over the reserved shared channel (block 645). As an illustrative example, the U-LTE device transmits or receives data over a resource of the shared channel. The U-LTE device completes the communications and prepares to release the shared channel (block 650). The U-LTE device returns to block 605.

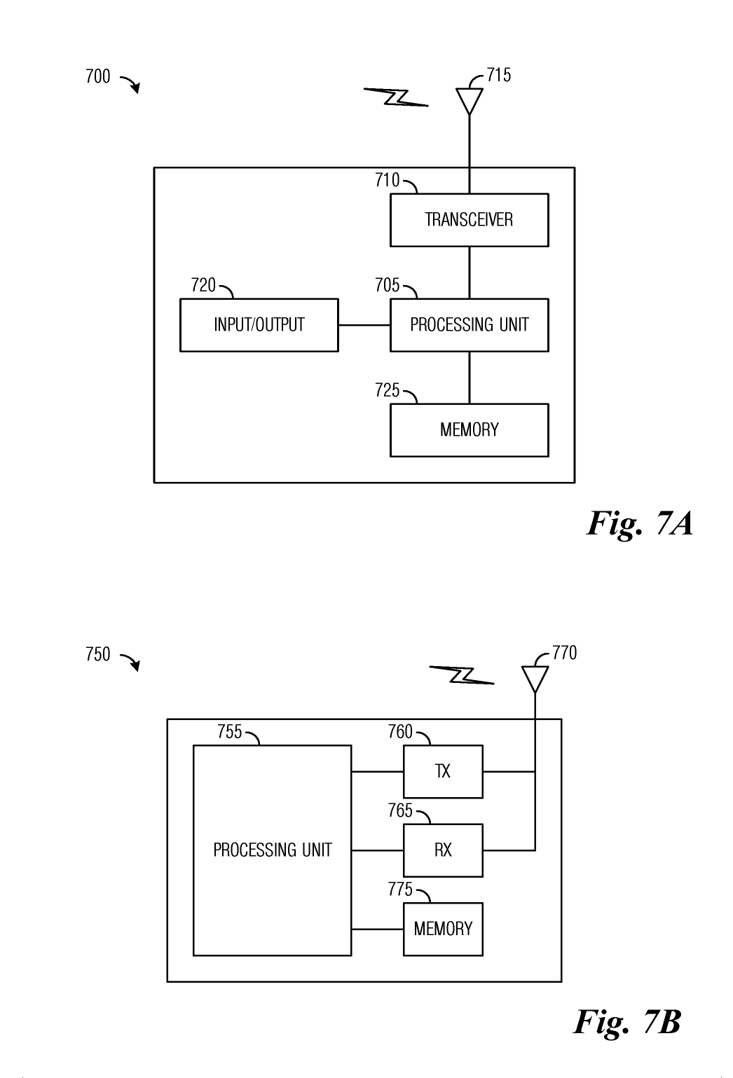

FIG. 7A illustrates an example UE 700. UE 700 includes at least one processing unit 705. Processing unit 705 implements various processing operations of UE 700. As an example, processing unit 705 may perform signal coding, data processing, power control, input/output processing, or any other functionality enabling UE 700 to operate in a wireless communications system. Processing unit 705 may support the embodiments presented herein. Processing unit 705 may include a microprocessor, a microcontroller, a digital signal processor, field programmable gate array, application specific integrated circuit, or multi-core processing system.

UE 700 also includes at least one transceiver 710 coupled to the processing unit 705. Transceiver 710 is configured to modulate data or other content for transmission by at least one antenna 715. Transceiver 710 is also configured to demodulate data or other content received by at least one antenna 715. Each transceiver 710 includes any suitable structure for generating signals for wireless transmission and/or processing signals received wirelessly. Each antenna 715 includes any suitable structure for transmitting and/or receiving wireless signals. One or multiple transceivers 710 could be used in UE 700, and one or multiple antennas 715 could be used in UE 700 and can be coupled to the transceiver 710. Although shown as a single functional unit, transceiver 710 could also be implemented using at least one transmitter and at least one separate receiver.

UE 700 further includes one or more input/output devices 720 coupled to the processing unit 705. Input/output devices 720 facilitate interaction with a user. Each input/output device 720 includes any suitable structure for providing information to or receiving information from a user, such as a speaker, microphone, keypad, keyboard, display, or touch screen.

In addition, UE 700 includes at least one memory 725 coupled to the processing unit 705. Memory 725 stores instructions and data used, generated, or collected by UE 700. For example, memory 725 could store software or firmware instructions executed by the processing unit(s) 705 and data used to reduce or eliminate interference in incoming signals. Each memory 725 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

FIG. 7B illustrates an example base station 750. Base station 750 includes at least one processing unit 755, at least one transmitter 760, at least one receiver 765, one or more antennas 770, and at least one memory 775. Processing unit 755 is coupled to the at least one transmitter 760, to the at least one receiver 765, and to the at least one memory 775. The one or more antennas 770 are coupled to the at least one transmitter 760 and to the at least one receiver 765. Processing unit 755 implements various processing operations of base station 750, such as signal coding, data processing, power control, input/output processing, or any other functionality. Processing unit 705 can also support the methods and teachings described in more detail below. For example, processing unit 705 is configured to control or support operations of base station 750 according to the standards and principles described below. Each processing unit 705 includes any suitable processing or computing device configured to perform one or more operations. Each processing unit 705 could, for example, include a microprocessor, microcontroller, digital signal processor, field programmable gate array, application specific integrated circuit or a multi-core processing system.

Each transmitter 760 includes any suitable structure for generating signals for wireless transmission to one or more UEs or other devices. Each receiver 765 includes any suitable structure for processing signals received wirelessly from one or more UEs or other devices. Although shown as separate components, at least one transmitter 760 and at least one receiver 765 could be combined into a transceiver. Each antenna 770 includes any suitable structure for transmitting and/or receiving wireless signals. While a common antenna 770 is shown here as being coupled to both transmitter 760 and receiver 765, one or more antennas 770 could be coupled to transmitter(s) 760, and one or more separate antennas 770 could be coupled to receiver(s) 765. Each memory 775 includes any suitable volatile and/or non-volatile storage and retrieval device(s).

Additional details regarding UEs 700 and base stations 750 are known to those of skill in the art. As such, these details are omitted here for clarity.

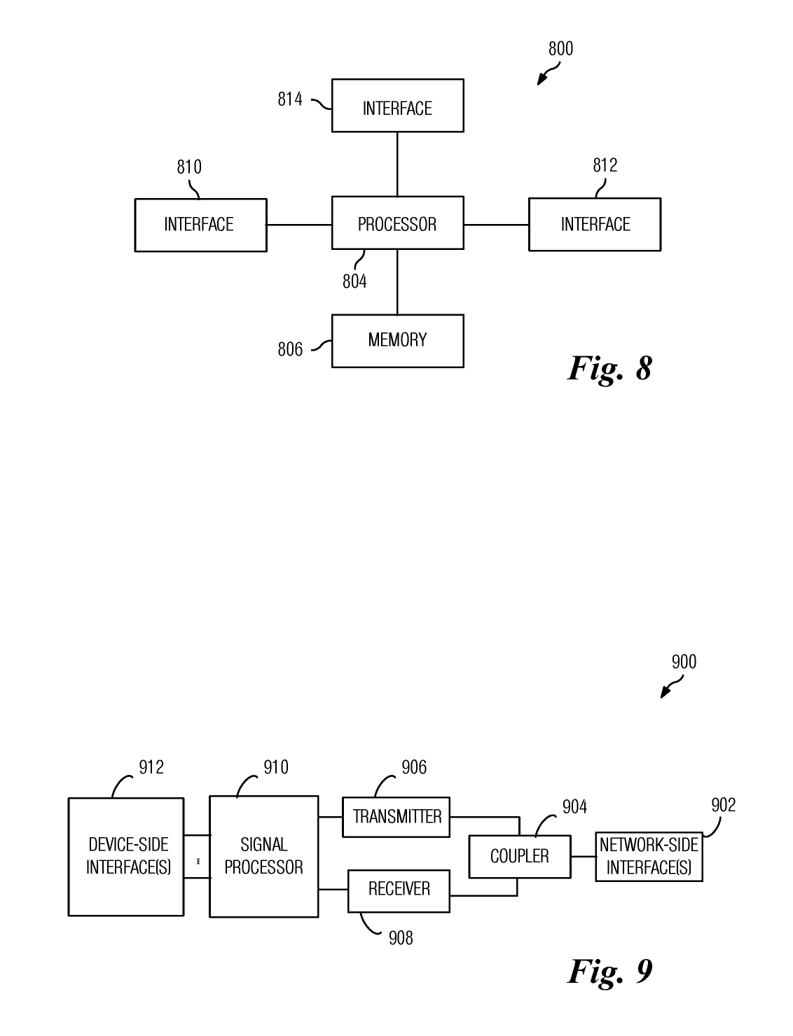

FIG. 8 illustrates a block diagram of an embodiment processing system 800 for performing methods described herein, which may be installed in a host device. As shown, the processing system 800 includes a processor 804, a memory 806, and interfaces 810-814, which may (or may not) be arranged as shown in FIG. 8. The processor 804 may be any component or collection of components adapted to perform computations and/or other processing related tasks, and the memory 806 may be any component or collection of components adapted to store programming and/or instructions for execution by the processor 804. In an embodiment, the memory 806 includes a non-transitory computer readable medium. The interfaces 810, 812, 814 may be any component or collection of components that allow the processing system 800 to communicate with other devices/components and/or a user. For example, one or more of the interfaces 810, 812, 814 may be adapted to communicate data, control, or management messages from the processor 804 to applications installed on the host device and/or a remote device. As another example, one or more of the interfaces 810, 812, 814 may be adapted to allow a user or user device (e.g., personal computer (PC), etc.) to interact/communicate with the processing system 800. The processing system 800 may include additional components not depicted in FIG. 8, such as long term storage (e.g., non-volatile memory, etc.).

In some embodiments, the processing system 800 is included in a network device that is accessing, or part otherwise of, a telecommunications network. In one example, the processing system 800 is in a network-side device in a wireless or wireline telecommunications network, such as a base station, a relay station, a scheduler, a controller, a gateway, a router, an applications server, or any other device in the telecommunications network. In other embodiments, the processing system 800 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 810, 812, 814 connects the processing system 800 to a transceiver adapted to transmit and receive signaling over the telecommunications network. FIG. 9 illustrates a block diagram of a transceiver 900 adapted to transmit and receive signaling over a telecommunications network. The transceiver 900 may be installed in a host device. As shown, the transceiver 900 comprises a network-side interface 902, a coupler 904, a transmitter 906, a receiver 908, a signal processor 910, and a device-side interface 912. The network-side interface 902 may include any component or collection of components adapted to transmit or receive signaling over a wireless or wireline telecommunications network. The coupler 904 may include any component or collection of components adapted to facilitate bi-directional communication over the network-side interface 902. The transmitter 906 may include any component or collection of components (e.g., up-converter, power amplifier, etc.) adapted to convert a baseband signal into a modulated carrier signal suitable for transmission over the network-side interface 902. The receiver 908 may include any component or collection of components (e.g., down-converter, low noise amplifier, etc.) adapted to convert a carrier signal received over the network-side interface 902 into a baseband signal. The signal processor 910 may include any component or collection of components adapted to convert a baseband signal into a data signal suitable for communication over the device-side interface(s) 912, or vice-versa. The device-side interface(s) 912 may include any component or collection of components adapted to communicate data-signals between the signal processor 910 and components within the host device (e.g., the processing system 800, local area network (LAN) ports, etc.).

The transceiver 900 may transmit and receive signaling over any type of communications medium. In some embodiments, the transceiver 900 transmits and receives signaling over a wireless medium. For example, the transceiver 900 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 902 comprises one or more antenna/radiating elements. For example, the network-side interface 902 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 900 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a push-forward duration determining unit/module, a channel reserving unit/module, an adjusting unit/module, and/or an incrementing unit/module. The respective units/modules may be hardware, software, or a combination thereof. For instance, one or more of the units/modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the spirit and scope of the disclosure as defined by the appended claims.

What is claimed is:

1. A method for reserving a shared channel in a wireless communications system, the method comprising:
when a first device has a communications to start at a first time, determining, by the first device, a push-forward duration in accordance with at least quality of service (QoS) information associated with the communications; and
performing, by the first device, at least one clear channel assessment (CCA) to reserve the shared channel at a second time that is before the first time by the push-forward duration.

2. The method of claim 1, wherein the QoS information comprises at least one of QoS requirements of the first device, QoS requirements of data being communicated, QoS requirements of a second device communicating with the first device, first device priority, second device priority, communications priority, and communications traffic type.

3. The method of claim 1, wherein the push-forward duration is determined in accordance with at least one of the following: QoS, which is a numerical representation of the QoS information, Tcca, which is a CCA observation time, Trts-cts, which is the minimum time to complete a request to send/clear to send (RTS/CTS) handshake among two or more devices, and Twifi, which is a maximum duration that the first device may wait before repeating an attempt to reserve the shared channel in order to prevent other devices from reserving the shared channel.

4. The method of claim 1, wherein the push-forward duration is determined in accordance with at least one of the following: OFFSET, which is a numerical representation of priority of the first device, Tcca, which is a CCA observation time, Trts-cts, which is the minimum time to complete a request to send/clear to send (RTS/CTS) handshake among two or more devices, and Twifi, which is a maximum duration that the first device may wait before repeating an attempt to reserve the shared channel in order to prevent other devices from reserving the shared channel.

5. The method of claim 1, further comprising:
when the first device is able to reserve the shared channel prior to the first time, communicating, by the first device, with a second device on the shared channel.

6. The method of claim 5, wherein communicating with the second device comprises:
transmitting, by the first device, an alternate transmission until the first time; and
communicating, by the first device, with the second device at the first time.

7. The method of claim 5, wherein communicating with the second device comprises:
communicating, by the first device, with the second device at a third time that is between the second time and the first time.

8. The method of claim 1, further comprising:
when the first device is unable to reserve the shared channel prior to the first time,
determining a third time for communicating with a second device,
adjusting the push-forward duration in accordance with the QoS information and reservation failure information, and
performing at least one second CCA to reserve the shared channel at a fourth time that is before the third time by the adjusted push-forward duration.

9. The method of claim 8, wherein adjusting the push-forward duration comprises increasing the push-forward duration.

10. The method of claim 1, further comprising:
when the first device is unable to reserve the shared channel prior to the first time,
incrementing a reservation failure counter,
determining a third time for communicating with a second device,
adjusting the push-forward duration in accordance with the QoS information and the reservation failure counter, and
performing at least one second CCA to reserve the shared channel at a fourth time that is before the third time by the adjusted push-forward duration.

11. A first device comprising:
a processor; and
a computer readable storage medium coupled to the processor and storing programming for execution by the processor, the programming including instructions to configure the first device to:
when the first device has a communications to start at a first time, determine a push-forward duration in accordance with at least quality of service (QoS) information associated with the communications, and
perform at least one clear channel assessment (CCA) to reserve a shared channel at a second time that is before the first time by the push-forward duration.

12. The first device of claim 11, wherein the programming includes instructions to configure the first device to determine the push-forward duration in accordance with at least one of the following: QoS_{D}, which is a numerical representation of the QoS information, Tcca, which is a CCA observation time, Trts-cts, which is the minimum time to complete a request to send/clear to send (RTS/CTS) handshake among two or more devices, and Twifi, which is a maximum duration that the first device may wait before repeating an attempt to reserve the shared channel in order to prevent other devices from reserving the shared channel.

13. The first device of claim 11, wherein the programming includes instructions to configure the first device to, when the first device is able to reserve the shared channel prior to the first time, communicate with a second device on the shared channel.

14. The first device of claim 13, wherein the programming includes instructions to configure the first device to transmit an alternate transmission until the first time, and communicate with the second device at the first time.

15. The first device of claim 11, wherein the programming includes instructions to configure the first device to, when the first device is unable to reserve the shared channel prior to the first time, determine a third time for communicating with a second device, adjust the push-forward duration in accordance with the QoS information and reservation failure information, and perform at least one second CCA to reserve the shared channel at a fourth time that is before the third time by the adjusted push-forward duration.

16. The first device of claim 11, wherein the first device is an unlicensed Third Generation Partnership Project (3GPP) Long Term Evolution (LTE) compliant device operating in a communications system supporting communications on both licensed and unlicensed carriers.

17. A non-transitory computer-readable medium storing programming for execution by a processor, the programming including instructions to:
when a first device has a communications to start at a first time, determine a push-forward duration in accordance with at least quality of service (QoS) information associated with the communications, and
perform at least one clear channel assessment (CCA) to reserve a shared channel at a second time that is before the first time by the push-forward duration.

18. The non-transitory computer-readable medium of claim 17, wherein the programming includes instructions to configure the first device to, when the first device is able to reserve the shared channel prior to the first time, communicate with a second device on the shared channel.

19. The non-transitory computer-readable medium of claim 18, wherein the programming includes instructions to configure the first device to transmit an alternate transmission until the first time, and communicate with the second device at the first time.

20. The non-transitory computer-readable medium of claim 17, wherein the programming includes instructions to configure the first device to, when the first device is unable to reserve the shared channel prior to the first time, determine a third time for communicating with a second device, adjust the push-forward duration in accordance with the QoS information and reservation failure information, and perform at least one second CCA to reserve the shared channel at a fourth time that is before the third time by the adjusted push-forward duration.
